(19) United States
(12) Patent Application Publication
(10) Pub. No.: US 2016/0292161 A1
(43) Pub. Date: Oct. 6, 2016

(54) ORGANIZATIONAL FIT

(71) Applicant: LinkedIn Corporation, Mountain View, CA (US)

(72) Inventors: Kun Liu, Sunnyvale, CA (US); Wen Pu, Santa Clara, CA (US); Anmol Bhasin, Los Altos, CA (US)

(21) Appl. No.: 14/675,738

(22) Filed: Mar. 31, 2015

(51) Int. Cl. G06F 17/30

(52) U.S. Cl. CPC G06F 17/3053; G06F 17/30864; G06Q 50/01

(57) ABSTRACT

Techniques for assisting a user in determining an affinity between a candidate and an organization. According to various embodiments, company data is received and includes a set of position characteristics and a set of pool characteristics. Member data is received and includes a set of member characteristics. A set of member characteristic scores are generated. Each characteristic score is based on comparing a member characteristic of the set of member characteristics with a position characteristic of the set of position characteristics and a pool characteristic of the set of pool characteristics. A member fit score is determined based on the set of member characteristic scores. A relative fit score is generated for the member based on a comparison of the member fit score and a set of second member fit scores for a second set of members. An identification of an organization is presented based on the relative fit score.

### TECHNICAL FIELD

The present application relates generally to data processing systems and, in one specific example, to techniques for assisting a user in determining an affinity between a candidate and an organization.

### BACKGROUND

Online social network services such as LinkedIn® are becoming increasingly popular, with many such websites boasting millions of active members. Each member of the online social network service is able to upload an editable member profile page to the online social network service. Further, online social network services such as LinkedIn® include a search feature where, for example, a member may search for other member profile pages, company profile pages, jobs, etc., posted on the online social network service.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 is a flowchart illustrating an example method, according to various embodiments;

FIG. 4 is a flowchart illustrating an example method, according to various embodiments;

FIG. 5 illustrates an example mobile device, according to various embodiments; and

FIG. 6 is a diagrammatic representation of a machine in the example form of a computer system within which a set of instructions, for causing the machine to perform any one or more of the methodologies discussed herein, may be executed.

### DETAILED DESCRIPTION

Example methods and systems for assisting a user in determining an affinity between a candidate and an organization (e.g., company) are described. In the following description, for purposes of explanation, numerous specific details are set forth in order to provide a thorough understanding of example embodiments. It will be evident, however, to one skilled in the art that the embodiments of the present disclosure may be practiced without these specific details.

Social networking services provide various profile options and services. In some instances a social network may connect members (e.g., individuals associated with the social network) and organizations alike. Social networking services have also become a popular method of performing organizational research and job searching. Job listings representing openings (e.g., employment and volunteer positions) within an organization may be posted and administered by the organization or third parties (e.g., recruiters, employment agencies, etc.).

Where the organization or third party is actively seeking out and contacting potential candidates for a position represented by a job listing, determining an affinity or organizational fit of between an organization and a candidate can be difficult. Where the organization or third party receives large volumes of applications or resumes from candidates (e.g., members of the social network) in response to the job listing, the organization or third party may encounter difficulties processing between candidates who are qualified and display and affinity for the organization and those which do not. Similarly, where a member of the social network receives a large number of job listings as a result of a query of the social networking service, it can be difficult for the member to discern an affinity with an organization or a specific job listing within the organization. Therefore, a better social network service would selectively generate and relay filtered search results (e.g., job listings, an identification of an organization, candidate members, etc.) representative of organizations or candidate members having a determined affinity.

An organizational fit system, serving as a portion of a social networking service or as a stand-alone social networking service, can determine an affinity between an organization and a member of the social network by generating one or more fit scores representing the determined affinity. The organizational fit system can then provide results based on the one or more fit scores. In some embodiments, the organizational fit system can generate the one or more fit scores based on organizational data (e.g., organization profile data of the social network) and member data (e.g., member profile data of the social network). For example, the organizational fit system can generate the one or more fit scores based on comparisons between member data representative of the member, job requirements (e.g., skills, experience, education, etc.) included within a job listing, employee data for current and former employees of the organization, and organization data representing the organization. The processes and methods of the organizational fit system and the data used therein will be described in further detail below.

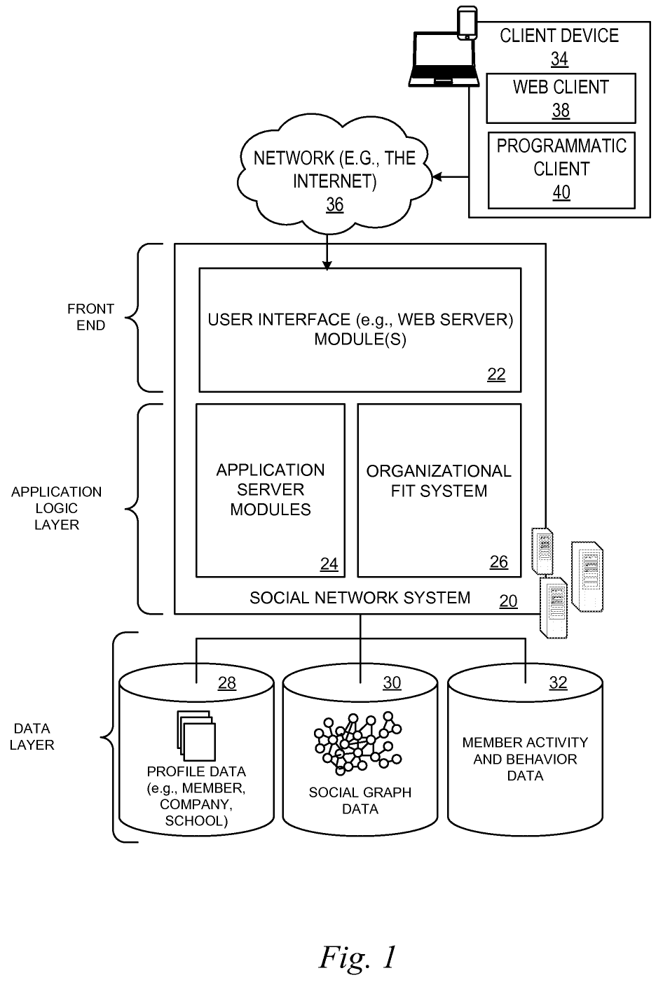

FIG. 1 is a block diagram illustrating various components or functional modules of a social network service such as the social network system 20, consistent with some embodiments. As shown in FIG. 1, the social network system includes a front end, an application logic layer, and a data layer. The front end includes a user interface module 22. The application logic layer includes an application server module 24 and an organizational fit system 26. The data layer contains at least one database 28. As shown, the at least one database 28 includes profile data, social graph data, and member activity and behavior data. Further, as shown the at least one database 28 may be a plurality of databases 28-32, with each database of the plurality of databases 28-32 containing a set of data including all or a portion of the profile data, the social graph data, and the member activity and behavior data. It will be understood that although shown as the plurality of databases 28-32, the data stored across the plurality of databases 28-32 can be stored on a single database 28.

The front end, consisting of the user interface module 22 (e.g., a web server) receives requests from various client-computing devices 34, and communicates appropriate responses to the requesting client devices 34. The user interface module 22 can communicate with the client devices 34 via a network 36. For example, the user interface module 22 may receive requests in the form of Hypertext Transport Protocol (HTTP), or other web-based, application programming interface (API) requests.

The application logic layer includes various application server modules 24, which, in conjunction with the user interface module(s) 22, generate various user interfaces (e.g., web pages) with data retrieved from various data sources in the data layer. In some instances, individual application server modules 24 are used to implement the functionality associated with various services and features of the social network service. For instance, services may include the ability of an organization (e.g., for-profit company, non-profit company, non-governmental organization, governmental entity, etc.) to establish a presence in the social graph of the social network service, including the ability to establish a customized web page on behalf of an organization, and to publish messages or status updates on behalf of an organization. These services may be implemented in independent application server modules 24 or in a single application server module 24. Similarly, a variety of other applications or services that are made available to members of the social network service can be embodied in their own application server modules 24.

The data layer includes the plurality of databases 28-32, such as a database 28 for storing profile data, including both member profile data as well as profile data for various organizations (e.g., company profile data and employee profile data). The database 30 stores various associations and relationships that members establish with other members or organizations (e.g., companies), or with other entities and objects. These associations and relationships are stored within a set of social graphs within the database 30. The database 32 stores member and organization interactions, activities, and behaviors within the social network.

With respect to the profile data stored in the database 28, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. Similarly, when a representative of an organization initially registers the organization with the social network service, the representative may be prompted to provide certain information about the organization. This information may be stored, for example, in the database 28, or another database (not shown).

In some embodiments, the profile data may be processed (e.g., in the background or offline) to generate various derived profile data. For example, if a first member has provided information about various job titles the member has held with the same organization or different organizations, and for how long, this information can be used to infer or derive a first member profile attribute indicating the first member's overall seniority level, or seniority level within a particular organization. Further, the derived profile data, indicative of an association with an organization or a second member (e.g., employment relationship or co-worker relationship), can be linked, included, or otherwise associated with the organization profile or the second member profile to represent the association (e.g., employment relationship or co-worker relationship) between the first member and the organization or second member. Additionally, in some instances, importing or otherwise accessing data from one or more externally hosted data sources may enhance profile data for both members and organizations. For instance, with companies in particular, financial data may be imported from one or more external data sources, and made part of an organization's profile. Once registered, a member may invite other members, or be invited by other members, to connect via the social network service.

Referring to the social graph data stored in the database 30, a “connection” may require a bi-lateral agreement by two members, such that both members acknowledge the establishment of the connection. Similarly, in some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream.

In any case, the various associations and relationships that the members establish with other members, or with other entities and objects, are stored and maintained within the social graph data, shown in FIG. 1 as stored in the database 30. The associations and relationships can include employment relationships (e.g., employer/employee relationships or co-worker relationships), professional associations (e.g., members in a common professional organization), social associations, scholastic associations (e.g., matriculation or graduation from a common school or educational institution), and other suitable associations.

In addition to connections and following, the social network service may provide a broad range of other applications and services that allow members the opportunity to share and receive information, often customized to the interests of the member. For example, with some embodiments, the social network service may include a photo sharing application that allows members to upload and share photos with other members. In some embodiments, members may be able to self-organize into groups, or interest groups, organized around a subject matter or topic of interest.

Further, in some instances, the social network service may host various job listings providing details of job openings with various organizations. The social network service can include paid job listings (where users have paid to post such jobs on the social network service), as well as unpaid job listings which may be ingested from third party websites. Such third party websites often post large numbers of similar or identical jobs having similar or identical employers, locations, job functions, position characteristics, etc. Previously, the paid job postings tend to be highly relevant to a certain job searchers, and the suggested facet-value pairs were tailored to that quality set of results. However, with the inflow of unpaid job listings, the same suggestions may be less relevant and, in some cases, lead to bad experiences. For example, the popularity metric (described above) for measuring a raw number of clicks may be skewed based on the ingestion of a large quantity of similar or identical job listings. As will be described below, the organizational fit system 26 can generate organizational fit metrics and provide data identifying companies or organizations which are determined to fit a member searching for a job or a member for whom a job is being searched.

As members interact with the various applications, services, and content made available via the social network service, the members' behavior (e.g., content viewed, links or member-interest buttons selected, etc.) are monitored and information concerning a member's activities and behavior may be stored, for example, in the database 32, as shown in FIG. 1.

The client device 34 contains a web client 38 which may access the social network service and the various applications, services, and content made available via the social network service, including at least some aspects of the organizational fit system 26, via a web interface supported by the user interface module 22 or the application server module 24. In some embodiments, the client device 34 can contain a programmatic client 40 configured to access certain of the various applications, services, and content made available via the social network service without use of the network 36 and/or the web client 38.

The network 36 may be any network that enables communication between or among machines (e.g., the social network system 20), databases (e.g., the databases 28-32), and devices (e.g., the client device 34). Accordingly, the network 36 can be a wired network, a wireless network (e.g., a mobile or cellular network), or any suitable combination thereof. The network 36 can include one or more portions that constitute a private network, a public network (e.g., the Internet), or any suitable combination thereof. Accordingly, the network 36 can include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 36 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

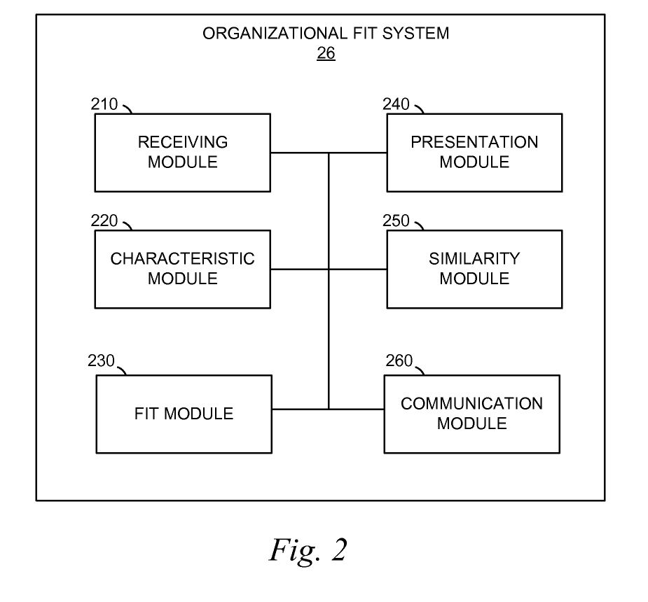

FIG. 2 is a block diagram illustrating components of the organizational fit system 26. The organizational fit system 26 is shown including a receiving module 210, a characteristic module 220, a fit module 230, a presentation module 240, a similarity module 250, and a communication module 260, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The receiving module 210 receives organization profile data (e.g., data representative of a company's profile) and member profile data. For example, the receiving module 210 can receive the organization profile data and the member profile data from the profile data stored on the database 28. The organization profile data and member profile data can be received by querying the database 28, an update of the organization profile data and member profile data from the database 28, scraping the organization profile data and member profile data from the database 28, or any other suitable method. The organization profile data includes a set of position characteristics and a set of pool characteristics. The member profile data includes a set of member characteristics.

A member characteristic can be understood as a portion of data representing a feature or quality of the member within the member profile which make up the qualifications of the member. For example, member characteristics can be a portion of data representing skills, educational history, school ranking, length of employment, certifications, awards, endorsements, publications, patents, previous employment positions and durations, and other features, qualities, or aspects of a member. The set of member characteristics can include all or a portion of the information contained within the member profile, such as the features or qualities of the member. Member characteristics within the set of member characteristics can be represented by text strings, integers, or any other data type capable of representing a feature, quality, aspect, or qualification of the member.

The set of position characteristics are representative of a set of characteristics of one or more employees associated with a specified position. For example, the set of position characteristics can include data representing educational history, school ranking, length of employment, seniority, company, company size, awards, certifications, endorsements, skills, publications, patents, previous employment positions and durations, previous employer, or any other characteristics associated with one or more employees of the organization who currently hold a position (e.g., the specified position) associated with a set of position characteristics. In some embodiments, where the specified position is not currently held by an employee within the organization, the set of position characteristics can be characteristics associated with one or more previous employees who held the specified position at one time, or characteristics associated with a position determined by the organizational fit system 26 to be similar to the specified position at an organization determined to be similar to the organization for which the set of position characteristics is to be associated, as described in more detail below.

In some embodiments, the set of pool characteristics are representative of a set of characteristics of one or more employees of the organization. For example, the one or more employees associated with the organization can include all current employees of an organization, all prior employees of an organization, or a combination thereof. In some instances, where the organization profile data, or associated member profile data and social graph data, does not include the set of pool characteristics (e.g., no current or former employees being members of the social network, or no members of the social network having a position within the organization indicated in their member profile), the receiving module 210 can receive an analogous set of pool characteristics from an organization determined, by the organizational fit system 26, to be similar to the organization for which the set of pool characteristics are absent, as described in more detail below. Similar to the set of position characteristics, the set of pool characteristics can include data representing skills, educational history, school ranking, length of employment, seniority, awards, certifications, endorsements, publications, patents, previous employment positions and durations, previous employer, or any other characteristics associated with one or more employees of the organization regardless of position held within the organization or current employment status within the organization.

In some embodiments, the set of pool characteristics are representative of a set of characteristics of a set of members of a social network within a predetermined market. The predetermined market can be selected from a group consisting of a geographical region, a technology field, and a business type. For example, in some instances, a portion of the set of pool characteristics can represent all of the people (e.g., members of the social network) employed within a geographic region. The set of pool characteristics can be narrowed based on desired aspects of the organizational fit sought. For example, the set of pool characteristics can include characteristics of members of the social network employed within a geographic region and within a technology field or business type so as to hone a determination of an organizational fit of a member within an organization and within a broader context of the area in which the organization is located.

The characteristic module 220 generates a set of member characteristic scores. Each member characteristic score of the set of member characteristic scores is based on a member characteristic of the set of member characteristics, a position characteristic of the set of position characteristics, and a pool characteristic of the set of pool characteristics. The characteristic module 220 determines a percentage of employees employed by the organization, in a position corresponding to the position characteristic, having a characteristic matching the member characteristic to generate a position percentage. The characteristic module 220 determines a percentage of employees, employed by the organization and representative of a pool characteristic, having a characteristic matching the member characteristic to generate a pool percentage. In this second calculation, the characteristic module 220 does not take into consideration the position of the employees for determination of the pool percentage. In generating a member characteristic score of the set of member characteristic scores, the characteristic module 220 performs one or more arithmetic operations on the position percentage and the pool percentage. For example, in some instances the characteristic module 220 takes a logarithm of a quotient of the position percentage divided by the pool percentage. In some embodiments, the characteristic module 220 weights an output of a comparison of the member characteristic and the position characteristic or the pool characteristic to prioritize the position characteristic or the pool characteristic, respectively, within the member characteristic score.

The fit module 230 determines a member fit score based on the set of member characteristic scores. The member fit score indicates an affinity between the member associated with the member fit score and the organization. The member fit score can be viewed as a likelihood model for the member and the organization. In some instances, the member fit score can be a metric representing a candidate who is similar to existing or prospective candidates seeking employment at an organization, and provide a basis for quantifying that similarity. The fit module 230 generates a relative fit score for the member based on the member fit score and a set of second member fit scores for a second set of members.

The presentation module 240 causes presentation of an identification of the organization based on the relative fit score. The presentation module 240 can cause presentation of the identification by transmitting the identification of the organization to the client device 34. The presentation module 240 can generate one or more user interface elements, screens, web pages, or the like, presenting the identification of the organization on the user interface of the client device 34. In some embodiments, the presentation system 240 causes presentation of the identification of the organization by transmitting data indicative of the identification of the organization to the client device 34. In some instances, a portion of the presentation module 240 can be implemented by the client device 34 (e.g., a portion of an application running on the client device 34) to cause presentation of the identification of the organization on the user interface. The presentation module 240 can be a hardware implemented module which configures the organizational fit system 26 or the client device 34 to perform the functions described above and below.

The similarity module 250 determines a similarity among a plurality of companies. The similarity module 250 can determine the similarity using data from the social network system 20, from other social networks, or from any suitable data source. The determination of similarity can be performed via comparisons of keywords, quantitative values extracted from the data, or any other suitable method.

The communication module 260 enables communication between the client device 34, the organizational fit system 26, the user interface 22, the application server modules 24, and the database 28. In some example embodiments, the communication module 260 enables communication among the receiving module 210, the characteristic module 220, the fit module 230, the presentation module 240, and the similarity module 250. The communication module 260 can be a hardware module and can incorporate software or processor executable instructions, explained in more detail below. In some instances, the communications module 260 includes communications mechanisms such as an antenna, a transmitter, one or more busses, and other suitable communication mechanisms capable of enabling communication between the modules 210-260, the client device 34, the user interface 22, the application server modules 24, and the database 28.

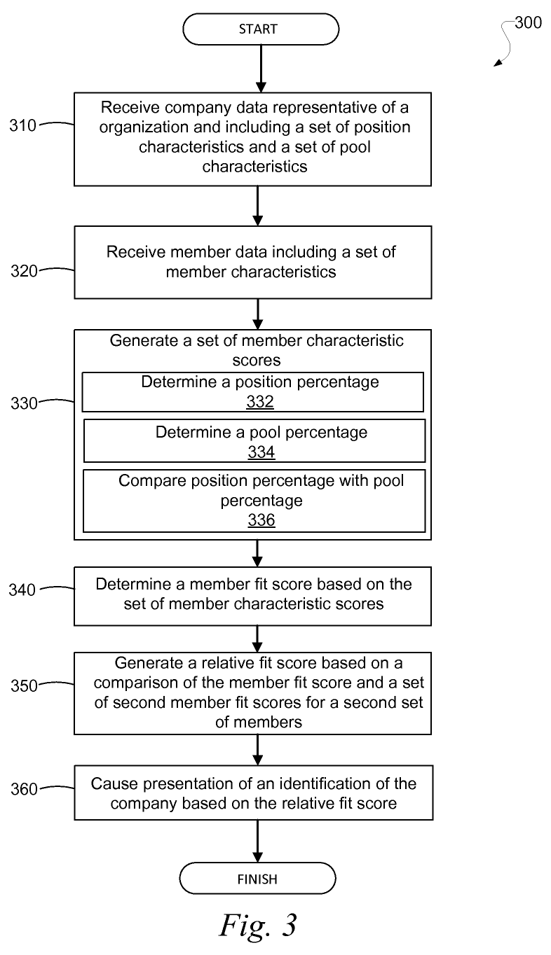

FIG. 3 is a flowchart illustrating an example method 300, consistent with various embodiments described herein. The method 300 may be performed at least in part by, for example, the organizational fit system 26 illustrated in FIG. 2 (or an apparatus having similar modules, such as one or more client machines or application servers).

In operation 310, the receiving module 210 receives organization data representative of an organization. In some embodiments, the organization data includes a set of position characteristics and a set of pool characteristics. In some instances, the organization data can comprise one or more of the organization profile data, job listings posted for the organization, derived profile data, and a set of member profile data (e.g., member profile data for one or more members associated with or employed by the organization). For example, the derived profile data can include position titles within the organization, minimum requirements (e.g., education, years of experience, etc.) for positions within the organization, characteristics (e.g., education background, years of experience, former positions/employers, skills, training, certifications, certificates, etc.) of members employed by the organization, and other information derived from one or more of the organization profile data, the job listings, the set of member profile data, and combinations thereof. In some embodiments, the set of pool characteristics can include all of the set of position characteristics for each position within the organization, such that the set of pool characteristics is representative of characteristics of all positions and employees (e.g., members of the social network) within the organization, and in some instances formerly employed by the organization.

The organization data can be received from the plurality of databases 28-32, the client device 34, or third party systems (e.g., web servers, social networks, etc.). Where the organization data is received from the plurality of databases 28-32, the organization data may be received by the receiving module 210 by querying the databases 28-32, an update of the organization data from the databases 28-32 (e.g., one or more of member profiles, company profiles, or job listings being updated by users of the social network), scraping the organization data from the databases 28-32, or any other suitable method. In any event, the organization data can be received by the receiving module 210 via the network 36, a bus, directly accessing the databases 28-32, or any other suitable method.

In operation 320, the receiving module 210 receives member data including a set of member characteristics. The member data can comprise member profile data and derived profile data. In some embodiments, the member data is received from the plurality of databases 28-32. In some instances, the member data is received from the client device 34. The member data can be received by the receiving module 210 based on a request from the member represented by the data or a third party member (e.g., a recruiter). For example, the member data can be received subject to a request to generate an organizational fit score by the member or the third party member, where the request causes one or more processes to retrieve or otherwise receive the member data. The member characteristics can include data representing name, age, and other demographic information; educational history (e.g., schools attended, degrees earned, school rankings, etc.); employment history (e.g., position titles, duration of tenure in a position, years of experience, employers, etc.); skills (e.g., languages fluency, programming languages, technology proficiencies, etc.); honors (e.g., awards, certifications, publications, etc.); and other characteristics.

In operation 330, the characteristic module 220 generates a set of member characteristic scores. Each member characteristic score is based on a comparison of a member characteristic of the set of member characteristics with a position characteristic of the set of position characteristics and a pool characteristic of the set of pool characteristics. The characteristic module 220 can generate the set of member characteristic scores using a probabilistic relevance model in the context of a probabilistic retrieval framework. As such, the member characteristic scores can form quantitative a basis for determining whether a member is a good fit for an organization and determining whether to present the member with the identification of the organization. In some embodiments, the characteristic module 220 generates a member characteristic score for each member characteristic included in the member data. In some instances, the set of member characteristic scores represents member characteristic scores generated for a subset of the member characteristics included within the member data.

In some embodiments, the member characteristic scores are generated by using a member characteristic of the set of member characteristics to identify a position characteristic of the set of position characteristics of the organization data and a pool characteristic of the set of pool characteristics of the organization data. The position characteristic and the pool characteristic are compared and that comparison determines the member characteristic score. For example, the first member characteristic can be an alma mater of the member (e.g., a school granting a degree to the member, such as Stanford University). The characteristic module 220 can determine the employees of the organization who attended Stanford University and are employed in a predetermined position within the organization (e.g., the position characteristic), as reflected by the set of position characteristics, and all employees of the organization who attended Stanford University regardless of position within the organization (e.g., the pool characteristic), as reflected by the set of pool characteristics. The characteristic module 220 the compares the position characteristic (e.g., the number of employees in the predetermined position who attended Stanford University) with the pool characteristic (e.g., the number of employees, regardless of position, who attended Stanford University) to generate the member characteristic score.

In some instances, the characteristic module 220 can use a plurality of member characteristics to generate the member characteristic score. Using the example above, the characteristic module 220 can use a first member characteristic, the alma mater (e.g., Stanford University) of the member, and a second member characteristic, a position title (e.g., software engineer) of the member, to generate the member characteristic score. In this example, the characteristic module 220 determines a first set of employees, who attended Stanford University and are employed as software engineers, from the set of position characteristics, and a second set of employees who attended Stanford University, regardless of position. The characteristic module 220 then compares the first set of employees to the second set of employees to generate the member characteristic score for the characteristic represented by the member's alma mater, with respect to the position title.

In some embodiments, operation 330 includes sub-operations. For example, in some instances, operation 330 includes operation 332, operation 334, and operation 336. In operation 332, the characteristic module 220 determines a position percentage. The position percentage represents a percentage of employees employed by the organization, in a position corresponding to the position characteristic, having a characteristic similar to (e.g., matching) the member characteristic. Using the example outlined above for a member who attended Stanford University and has the title of software engineer, the characteristic module 220 can determine the position percentage as the percentage of employees working for the organization who attended Stanford University and are employed as a software engineer.

In operation 334, the characteristic module 220 determines a pool percentage. The pool percentage represents a percentage of members in a predetermined market having a characteristic matching the member characteristic. In some instances, the characteristic module 220 determines the pool percentage without regard to the position held by each member included in the pool percentage. Using the example outlined above, the characteristic module 220 can determine the pool percentage as the percentage of members working in the predetermined market (e.g., a geographic area or location, an industry, a combination of an industry and geographic location, etc.) who attended Stanford University regardless of position.

In operation 336, the characteristic module 220 generates the member characteristic score by performing one or more operations to compare the position percentage with the pool percentage. In some instances, the characteristic module 220 generates the member characteristic score by first dividing the position percentage and the pool percentage to generate a score quotient. The characteristic module 220 then takes the logarithm of the score quotient to produce the member characteristic score. Using the example of a member from Stanford University working as a software engineer, the characteristic module 220 can determine that the position percentage is 5% and the pool percentage is 1%, determine the score quotient of 5, and generate the member characteristic score as 0.70 (e.g., taking the logarithm of the score quotient of 5).

In operation 340, the fit module 230 determines a member fit score based on the set of member characteristic scores. In some embodiments, the member fit score can be the member characteristic score. In some instances, the fit module 230 determines the member fit score based on an aggregation of the set of member characteristic scores or a subset of the set of member characteristic scores.

Where the set of member characteristic scores include scores for member characteristics which relate to a predetermined characteristic aspect (e.g., programming languages known to the member), the fit module 230 can generate an aggregate member characteristic score for the subset relating to the predetermined characteristic aspect. For example, the member who graduated from Stanford University and works as a software engineer can work in a set of programming languages including Java, C++, and Python. In this example, the characteristic module 220 generates a member characteristic score for each programming language, with the member characteristic scores being 0.3 for Java, −1.3 for C++, and 0.48 for Python.

The fit module 230, determining the aggregate member characteristic score for the characteristic of programming languages, can aggregate the scores for the set of programming languages (e.g., the entire set of programming languages or a subset of the set of programming languages). For example, the member fit score can be an aggregation of a subset of the set of programming languages. In this example, the fit module 230 can average a subset of the top skills of the set of programming languages, thereby delimiting the set of characteristic scores to a subset of characteristic scores. The fit module 230 may determine the top two skills are Java and Python, based on their respective member characteristic scores. The fit module 230, averaging the member characteristic scores for Java and Python, generates the member fit score of 0.39. As described in this example, the fit module 230 has determined a member fit score representative of the member characteristic scores for programming languages (e.g., a single field). However, it will be understood by one skilled in the art that the fit module 230 can determine a member fit score including any number of the set of member characteristic scores. In some embodiments, the member characteristic scores included in the member fit score may be selected for inclusion by the member for whom the score is generated, by a third party, a machine, a computer program, or any other entity capable of providing input to the fit module 230 and the organizational fit system 26.

In operation 350, the fit module 230 generates a relative fit score for the member based on a comparison of the member fit score and a set of second member fit scores for a second set of members. The set of second member fit scores are generated using the operations 310-340, outlined above.

In some embodiments, the relative fit score is a fit score range extending between a lowest fit score and a highest fit score among the member fit score and the set of second member fit scores. The relative fit score can be determined by graphical analysis, or any other suitable form of analysis, of the member fit score and the set of second member fit scores. In these embodiments, the fit module 230 graphs the member fit score and the set of second member fit scores in relation to one another to determine the fit score range for the relative fit score. The fit module 230 can divide the fit score range into categories based on the relative position of the fit scores within the fit score range to represent a level of organizational fit. For example, the fit score range can be divided into percentiles, where higher percentiles indicate a higher relative fit score (e.g., the member fit score being higher relative to the set of second member fit scores) and an organizational fit indicating the member shares characteristics relevant to a specified position and members occupying that position.

The second set of members are members of the social network. In some embodiments, the second set of members may have been determined to be similar to the member for which the member fit score has been generated and to whom the second set of members are being compared. In some embodiments, the second set of members includes members associated with the organization (e.g., current employees or former employees). In some instances, the second set of members includes members associated with a second set of companies, determined by the organizational fit system 26 to be similar to the organization associated with the member fit score being generated. For example, when the member fit score is being generated to determine an organizational fit of a member for a position at a software company (e.g., LinkedIn®), the second set of members can be selected from members of the social network who are associated with the second set of companies similar to the software company (e.g., FaceBook®, Google®, Yahoo®, Oracle®, etc.). The second set of members can also include members who have applied for positions with the organization or a second company determined to be similar to the organization for which the organizational fit is being determined.

In some embodiments, in operation 350, the similarity module 250 is configured to determine a similarity between the first company and the second company. The similarity module 250 can determine the similarity between the first company and the second company by a comparison among the first company and the second company of job postings, current employees, former employees, company data associated with the first company and the second company, and member data associated with the first company and the second company. In some embodiments, the similarity module 250 determines similarity among the first company and the second company by comparison of keywords within the above-referenced data sources or any other suitable method.

In operation 360, the presentation module 240 causes presentation of an identification of the organization based on the relative fit score. For example, the presentation module 240 receives the identification of the organization from the database 28 and an indication of the relative fit score from the fit module 230. The presentation module 240 can generate one or more user interface screens or user interface elements and include a graphical representation, a network link, a written description, or other representation of the identification of the organization based on a determination (e.g., a determination by the fit module 230 or the presentation module 240) that the relative fit score exceeds a predetermined value (e.g., a predetermined percentile, a predetermined relative fit score, etc.). The presentation module 240 then cause presentation of the identification of the organization on the user interface by transmitting the representation of the identification of the organization to the client device 34, causing the client device 34 to display the identification of the organization on a screen of the client device 34.

In some embodiments, the operations 310-360 can be performed in response to a search by the member for job listings posted on the social network system 20. In these embodiments, the presentation module 240 can cause presentation of the identification of the organization within the search results responsive to the search by the member for job postings. Where the search includes a plurality of companies, with a relative fit score generated for each company of the plurality of companies, the presentation module 240 can cause presentation of the identifications of a set of the plurality of companies based on the relative fit scores for those companies. For example, in some instances, the presentation module 240 can rank the presentation of the identifications in an order from highest relative fit score to lowest relative fit score.

In some embodiments, the presentation module 240 can cause presentation of the identifications of the set of the plurality of companies based on a combination of the relative fit scores generated for each of the plurality of companies and the search of the member. For example, the presentation module 240 can cause presentation of the identifications of the set of the plurality of companies based on relevance or other metric, in response to the search conducted by the member or third party member. The presentation module 240 can resolve conflicts (e.g., two companies having the same position based on relevance or other metric) based on the relative fit score for the companies (e.g., listing first the organization with the higher relative fit score).

In some instances, the presentation module 240 can cause presentation of identifications of members of the social network system 20 based on the relative fit scores. For example, where the third party member is a recruiter, the organizational fit system 26 can perform operations 310-350 based on a designation of an organization by the recruiter. The presentation module 240, in operation 360 can present identifications of members based on the relative fit scores to enable the recruiter to identify candidates for contact with regard to job postings or openings for the organization. In some embodiments, where the recruiter is searching among the members of the social network system 20 to determine candidates who may have a suitable organizational fit with a specified organization, the operations 320-350 of the method 300 may be repeated for each member returned by a search of the members. In these instances, the presentation module 240 can cause presentation of identifications of a set of members after determining their relative fit score for the specified organization. The presentation module 240 can cause presentation of identifications of members of the set of members who have a relative fit score exceeding a predetermined threshold.

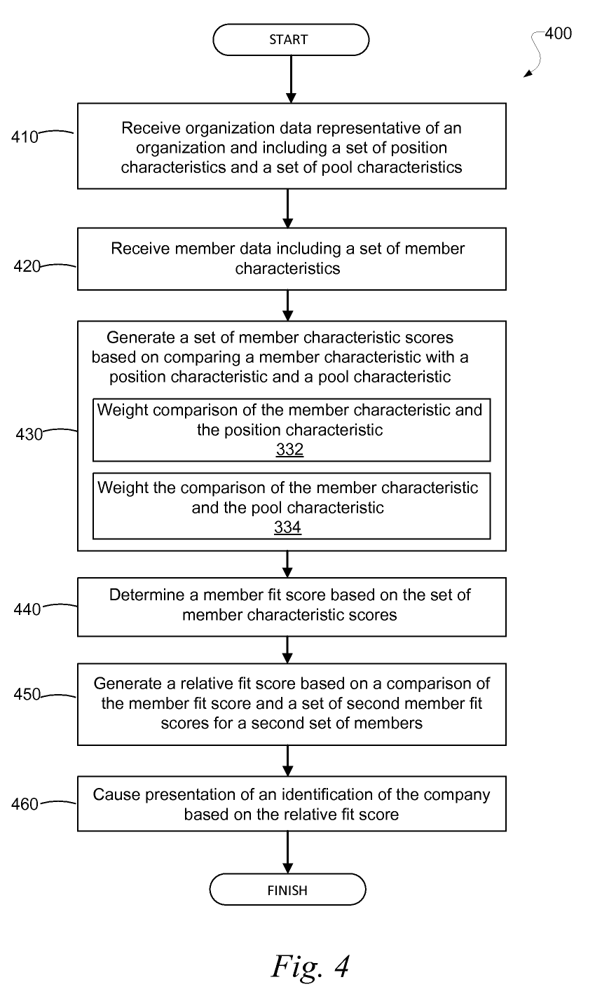

The presentation module 240 can cause presentation of the identifications of the set of members in an order based on the relative fit scores of each member of the set of members. For example, the presentation module 240 can determine a ranked order based on the relative fit scores of the set of members and present the identifications of the set of members in a list beginning with the member associated with the highest relative fit score and presenting the other identifications in a descending order. In some instances, where the organization has weighted one or more member characteristics, discussed in more detail with respect to FIG. 4, the order may be weighted based on the weighted member characteristics. For example, the organization may wish to emphasize hiring candidates having a specified one or more member characteristics. The order, based on relative fit score, may be modified to prioritize one or more members of the set of members based on a higher member characteristic score associated with the weighted one or more member characteristics, even where the overall relative fit score is lower than that of another member within the set of members.

In some embodiments, the presentation module 240 may cause presentation of a set of identifications of a set of organizations based on the relative fit score. Portions of the method 300 may be performed based on actions of a member or of a third party (e.g., a recruiter) for a set of organizations (e.g., a plurality of organizations identified in a search, a job listing search, etc.). For example, operations 310 and 330-350 may be performed to generate a relative fit score for each organization of the set of organizations to form a set of relative fit scores. As such, in some instances in operation 360, the presentation module 240 may cause presentation of the set of identifications of the set of organizations in an order or rank based on the set of relative fit scores. The presentation module 240 can determine an order for the set of relative fit scores (e.g., a descending order starting with the highest relative fit score) for presentation to the member or the third party. For example, the presentation module 240 can cause presentation of the set of organization identifications in a list of HTML links based on the order, with the organization associated with the highest relative fit score being presented first (e.g., at a top of a screen or user interface display).

In some embodiments, the presentation module 240 can prevent presentation of one or more of the set of organization identifications based on the relative fit score generated for that organization being below a threshold indicating a poor fit, or indicating a poor fit with respect to the remaining relative fit scores for the set of organizations. In these embodiments, the presentation module 240 can reserve the one or more organization identifications for presentation on a subsequent screen or page of a user interface. The presentation module 240 may also enable the user to choose (e.g., make a selection) indicating an instruction to display the one or more organization identifications associated with a relative fit score below the threshold.

FIG. 4 is a flowchart illustrating an example method 400, consistent with various embodiments described herein. The method 400 may be performed at least in part by, for example, the organizational fit system 26 illustrated in FIG. 2 (or an apparatus having similar modules, such as one or more client machines or application servers). In some embodiments, the method 400 includes one or more operations from the method 300, as shown in FIG. 4 and described below.

In operation 410, the receiving module 210 receives company data representative of an organization. The organization data includes a set of position characteristics and a set of pool characteristics. In some embodiments, the operation 410 can be performed similarly to operation 310, described above.

In operation 420, the receiving module 210 receives member data including a set of member characteristics. The member data can comprise member profile data and derived profile data. In some instances, the operation 420 can be performed similarly to operation 320, described above.

In operation 430, the characteristic module 220 generates a set of member characteristic scores. Each characteristic score is based on comparing a member characteristic of the set of member characteristics with a position characteristic of the set of position characteristics and a pool characteristic of the set of pool characteristics. In some embodiments, operation 430 includes one or more sub-operations. For example, the sub operations can include 432 and 434.

In operation 432, the characteristic module 220 weights the comparison of the member characteristic and the position characteristic to prioritize the position characteristic within the member characteristic score. In some embodiments, the characteristic module 220 can prioritize the position characteristic by directly weighting the position characteristic prior to comparison with the pool characteristic. For example, the characteristic module 220 can increase a value for the position characteristic to cause prioritization of the position characteristic within the member characteristic score. By way of illustration, where the member characteristic score is determined based on dividing a first value for the position characteristic by a second value for the pool characteristic and taking the logarithm of a resulting quotient, the characteristic module 220 can prioritize the position characteristic by increasing or decreasing the first value.

In some embodiments, the characteristic module 220 can weight the comparison to prioritize the position characteristic based on receiving a prioritization value. In these embodiments, the prioritization value can be received by the characteristic module 220 or the receiving module 210 and be added to a value representative of the position characteristic, or otherwise increment or decrement the value of the position characteristic. For example, where the characteristic module 220 uses a position percentage, the position percentage can be a first position percentage representative of the current percentage of employees in a specified position within the organization and having a specified position characteristic (e.g., 2.5% of the software engineers being Stanford University Alumni). The prioritization value can increment the first position percentage to generate a second position percentage representative of a desired percentage of members of the organization having a specified characteristic within a specified position (e.g., 3.6% of software engineers being Stanford University Alumni). For example, where the Stanford University software engineers currently make up 2.5% of software engineers for an organization and the organization wants have a software engineer composition including 3.6% of Stanford University Alumni the prioritization value can be 1.1.

In operation 434, the characteristic module 220 weights the comparison of the member characteristic and the pool characteristic to prioritize the pool characteristic within the member characteristic score. Similar to operation 432, the characteristic module can weight the comparison to prioritize the pool characteristic be incrementing or decrementing a value for the pool characteristic. Using the position percentage and pool percentage example, where the member characteristic score is a result of dividing the position percentage by the pool percentage and taking the logarithm of the resulting quotient, the characteristic module 220 can weight the pool characteristic for prioritization (e.g., increasing or decreasing the number of members within the pool having a specified characteristic) by incrementing or decrementing the pool percentage. For example, where the organization chooses to decrease the overall percentage of Stanford University Alumni in its pool of employees, the prioritization value can increase the pool percentage to generate a smaller quotient when dividing the position percentage by the pool percentage.

In operation 440, the fit module 230 determines a member fit score based on the set of member characteristic scores. In some instances, the member fit score can be the member characteristic score. In some instances, the fit module 230 can determine the member fit score based on an aggregation of the set of member characteristic scores or a subset of the set of member characteristic scores. In at least some embodiments, operation 440 can be performed similarly to operation 340.

In operation 450, the fit module 230 generates a relative fit score for the member based on a comparison of the member fit score and a set of second member fit scores for a second set of members. In some embodiments, operation 450 can be performed similarly to operation 350, described above.

In operation 460, the presentation module 240 causes presentation of an identification of the organization based on the relative fit score. The presentation module 240 generates one or more user interface screens or user interface elements (e.g., a graphical representation, a network link, a written description) to represent the identification of the organization based on a determination that the relative fit score exceeds a predetermined value. In some instances, operation 460 can be performed, by the presentation module 240, similarly to the operation 360, described above.

### Example Mobile Device

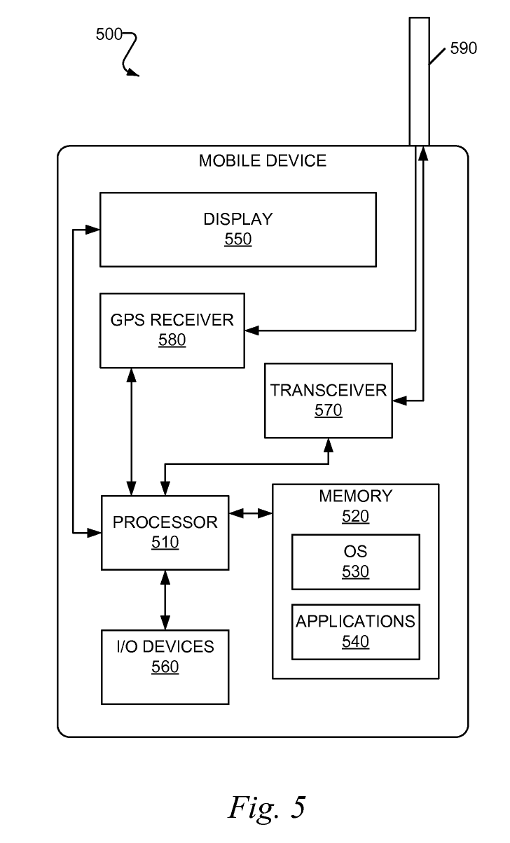

FIG. 5 is a block diagram illustrating the mobile device 500, according to an example embodiment. The mobile device may correspond to, for example, one or more client machines or application servers. In some embodiments, the mobile device 500 can include at least a portion of the organizational fit system. In some instances, the mobile device 500 can communicate with the application server modules 24 and at least a portion of the organizational fit system 26, stored on a separate machine or computing system, to enable a user of the mobile device 500 to interact with the organizational fit system 26. For example, the mobile device 500 can act as an input for user or member entered data (e.g., member data entered into the social network system 20, search queries, or input used by the method 300 or the method 400) and an output for causing presentation of user interface elements by the presentation module 240. In some instances, one or more of the modules of the organizational fit system 26 illustrated in FIG. 2 may be implemented on or executed by the mobile device 500.

The mobile device 500 may include a processor 510. The processor 510 may be any of a variety of different types of commercially available processors suitable for mobile devices (for example, an XScale architecture microprocessor, a Microprocessor without Interlocked Pipeline Stages (MIPS) architecture processor, or another type of processor). A memory 520, such as a Random Access Memory (RAM), a Flash memory, or other type of memory, is typically accessible to the processor 510. The memory 520 may be adapted to store an operating system (OS) 530, as well as application programs 540, such as a mobile location enabled application that may provide location based services to a user. The processor 510 may be coupled, either directly or via appropriate intermediary hardware, to a display 550 and to one or more input/output (I/O) devices 560, such as a keypad, a touch panel sensor, a microphone, and the like. Similarly, in some embodiments, the processor 510 may be coupled to a transceiver 570 that interfaces with an antenna 590. The transceiver 570 may be configured to both transmit and receive cellular network signals, wireless data signals, or other types of signals via the antenna 590, depending on the nature of the mobile device 500. Further, in some configurations, a GPS receiver 580 may also make use of the antenna 590 to receive GPS signals.

### Modules, Components and Logic

Certain embodiments are described herein as including logic or a number of components, modules, or mechanisms. Modules (e.g., the receiving module 210, the characteristic module 220, the fit module 230, the presentation module 240, the similarity module 250, and the communication module 260) may constitute either software modules (e.g., code embodied (1) on a non-transitory machine-readable storage medium or (2) in a transmission signal and configuring hardware components of a machine or computer system) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable storage medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

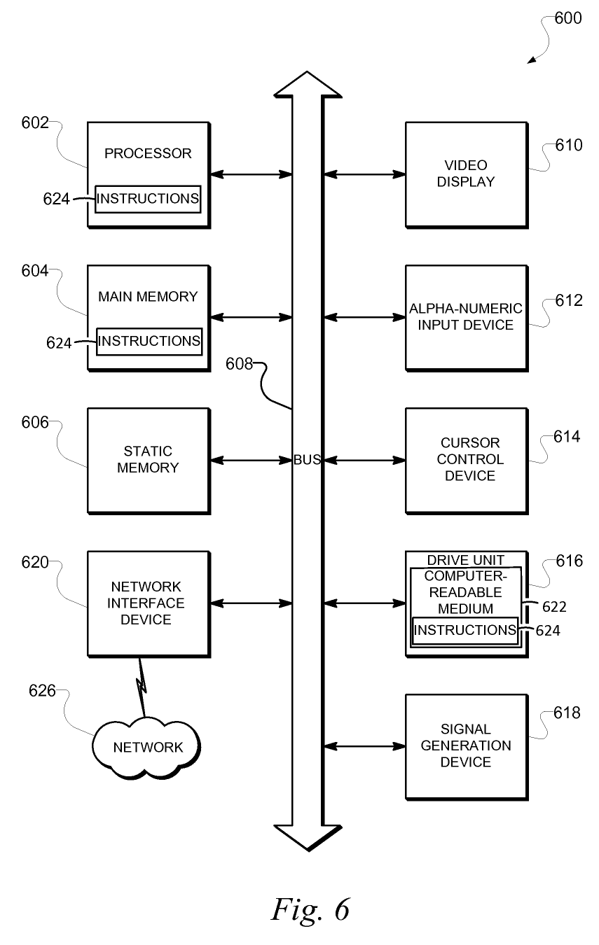

FIG. 6 is a block diagram of machine in the example form of a computer system 600 within which instructions, for causing the machine to perform any one or more of the methodologies discussed herein, may be executed. For example, the computer system 600 can form part or all of the social network system 20, store the profile data, social graph data, and member activity and behavior data of the data layer described in FIG. 1, and provide an interface through which the application server modules 24 and at least a portion of the organizational fit system 26 can be accessed. In some instances, the computer system can form all or a portion of the organizational fit system 26 and include the receiving module 210, the characteristic module 220, the fit module 230, the presentation module 240, the similarity module 260, and the communication module 260.

The machine can operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard or a touch-sensitive display screen), a user interface (UI) navigation device 614 (e.g., a mouse), a disk drive unit 616, a signal generation device 618 (e.g., a speaker) and a network interface device 620.

### Machine-Readable Storage Medium

The disk drive unit 616 includes a machine-readable storage medium 622 on which is stored one or more sets of instructions and data structures (e.g., software) 624 embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

While the machine-readable storage medium 622 is shown in an example embodiment to be a single storage medium, the term “machine-readable storage medium” may include a single storage medium or multiple media (e.g., a centralized or distributed database, and/or associated caches and servers) that store the one or more instructions or data structures. The term “machine-readable storage medium” shall also be taken to include any tangible storage medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable storage medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system, comprising:
one or more processors; and
a non-transitory machine-readable storage medium comprising processor executable instructions that, when executed by a processor of a machine, cause the machine to perform operations comprising:
receiving organization data associated with an organization and member data associated with members of an online social networking service, the organization data including a set of position characteristics and a set of pool characteristics, the member data including a set of member characteristics;
generating a set of member characteristic scores, each characteristic score being based on a member characteristic of the set of member characteristics, a position characteristic of the set of position characteristics, and a pool characteristic of the set of pool characteristics, the set of member characteristics scores generated by, for two or more sub-characteristics of each member characteristic:
determining a position percentage representing a percentage of employees in a position corresponding to the position characteristic,
determining a pool percentage representing a percentage of members in a predetermined market having a characteristic matching the member characteristic,
determining scores for the two or more sub-characteristics based on the position percentage and the pool percentage,
determining one or more sub-characteristics for inclusion in the member characteristic score, and
determining the member characteristic score based on the scores for the one or more sub-characteristics determined for inclusion in the member characteristic score;
determining a member fit score based on the set of member characteristic scores and to generate a relative fit score based on the member fit score and a set of second member fit scores for a second set of members, the member fit score indicating a determined affinity between a member associated with the member fit score and the organization, the relative fit score generated by determining a position of the member fit score among the set of second member fit scores; and
causing presentation of an identification of the organization based on the relative fit score.

2. The system of claim 1, wherein the set of position characteristics are representative of a set of characteristics of one or more employees associated with a specified position.

3. The system of claim 1, wherein the organization is a first organization and the organization data is associated with the first organization and a second organization, the processor executable instructions further causing the machine to perform operations comprising:
determining a similarity between the first organization and the second organization.

4. The system of claim 1, wherein the set of pool characteristics are representative of a set of characteristics of one or more employees associated with the organization.

5. The system of claim 1, wherein the set of pool characteristics are representative of a set of characteristics of a set of members employed within a predetermined market.

6. The system of claim 5, wherein the predetermined market is selected from a group consisting of a geographical region, a technology field, and a business type.

7. The system of claim 1, wherein the processor executable instructions further causing the machine to perform operations comprising determining a percentage of employees employed by the organization, in a position corresponding to the position characteristic, having a characteristic matching the member characteristic.

8. The system of claim 1, wherein the processor executable instructions further causing the machine to perform operations comprising determining a percentage of employees, employed by the organization and representative of the pool characteristic, having a characteristic matching the member characteristic.

9. The system of claim 1, wherein the processor executable instructions further causing the machine to perform operations comprising weighting an output of a comparison of the member characteristic and the position characteristic to prioritize the position characteristic within the member characteristic score.

10. The system of claim 1, wherein the processor executable instructions further causing the machine to perform operations comprising weighting an output of a comparison of the member characteristic and the pool characteristic to prioritize the pool characteristic within the member characteristic score.

11. The system of claim 1, wherein the processor executable instructions further causing the machine to perform operations comprising delimiting the set of characteristic scores to a subset of characteristic scores, the subset of characteristic scores determined for inclusion based on a predetermined characteristic aspect.

12. The system of claim 1, wherein the member fit score is an aggregation of the set of characteristic scores.

13. A method, comprising:
receiving company data associated with an organization, the organization data including a set of position characteristics and a set of pool characteristics;
receiving member data associated with members of an online social networking service, the member data including a set of member characteristics;
generating, by one or more processors a set of member characteristic scores, each characteristic score being based on comparing a member characteristic of the set of member characteristics with a position characteristic of the set of position characteristics and a pool characteristic of the set of pool characteristics, the set of member characteristics scores generated by, for two or more sub-characteristics of each member characteristic:
determining, by the one or more processors, a position percentage representing a percentage of employees in a position corresponding to the position characteristic,
determining a pool percentage representing a percentage of members in a predetermined market having a characteristic matching the member characteristic,
determining scores for the two or more sub-characteristics based on the position percentage and the pool percentage,
determining one or more sub-characteristics for inclusion in the member characteristic score, and
determining the member characteristic score based on the scores for the one or more sub-characteristics determined for inclusion in the member characteristic score;
based on the set of member characteristic scores, determining a member fit score indicating a determined affinity between a member associated with the member fit score and the organization;
generating a relative fit score based on a comparison of the member fit score and a set of second member fit scores for a second set of members, the relative fit score generated by determining a position of the member fit score among the set of second member fit scores; and
causing presentation of an identification of the organization based on the relative fit score.

14. The method of claim 13, wherein comparing the member characteristic with the position characteristic further comprises:
determining a percentage of employees employed by the organization, in a position corresponding to the position characteristic, having a characteristic matching the member characteristic.

15. The method of claim 13, wherein comparing the member characteristic with the pool characteristic further comprises:
determining a percentage of employees employed by the organization having a characteristic matching the member characteristic.

16. The method of claim 13 further comprising:
weighting the comparison of the member characteristic and the position characteristic to prioritize the position characteristic within the member characteristic score.

17. The method of claim 13 further comprising:
weighting the comparison of the member characteristic and the pool characteristic to prioritize the pool characteristic within the member characteristic score.

18. A non-transitory machine-readable storage medium comprising processor executable instructions that, when executed by a processor of a machine, cause the machine to perform operations comprising:
receiving company data associated with an organization, the organization data including a set of position characteristics and a set of pool characteristics;
receiving member data associated with members of an online social networking service, the member data, the member data including a set of member characteristics;
generating a set of member characteristic scores, each characteristic score being based on comparing a member characteristic of the set of member characteristics with a position characteristic of the set of position characteristics and a pool characteristic of the set of pool characteristics, the set of member characteristics scores generated by, for two or more sub-characteristics of each member characteristic:
determining a position percentage representing a percentage of employees in a position corresponding to the position characteristic,
determining a pool percentage representing a percentage of members in a predetermined market having a characteristic matching the member characteristic,
determining scores for the two or more sub-characteristics based on the position percentage and the pool percentage,
determining one or more sub-characteristics for inclusion in the member characteristic score, and
determining the member characteristic score based on the scores for the one or more sub-characteristics determined for inclusion in the member characteristic score;
based on the set of member characteristic scores, determining a member fit score indicating a determined affinity between a member associated with the member fit score and the organization;
generating a relative fit score based on a comparison of the member fit score and a set of second member fit scores for a second set of members, the relative fit score generated by determining a position of the member fit score among the set of second member fit scores; and
causing presentation of an identification of the organization based on the relative fit score.

19. The non-transitory machine-readable storage medium of claim 18, wherein comparing the member characteristic with the position characteristic includes determining a percentage of employees employed by the organization, in a position corresponding to the position characteristic, having a characteristic matching the member characteristic, and comparing the member characteristic with the pool characteristic includes determining a percentage of employees employed by the organization having a characteristic matching the member characteristic.

20. The non-transitory machine-readable storage medium of claim 18, wherein the operations further comprise:
weighting the comparison of the member characteristic and the position characteristic to prioritize the position characteristic within the member characteristic score; and
weighting the comparison of the member characteristic and the pool characteristic to prioritize the pool characteristic within the member characteristic score.
